(19) United States
(12) Patent Application Publication
(10) Pub. No.: US 2012/0047341 A1
(43) Pub. Date: Feb. 23, 2012

(54) DATA RECOVERY APPARATUS AND DATA RECOVERY METHOD

(75) Inventors: Yuunosuke ISHINABE, Kawasaki (JP); Yuzuru Ueda, Kawasaki (JP)

(73) Assignee: Fujitsu Limited, Kawasaki (JP)

(21) Appl. No.: 13/207,906

(22) Filed: Aug. 11, 2011

(30) Foreign Application Priority Data
Aug. 18, 2010 (JP) 2010-183435

(51) Int. Cl. G06F 12/16

(52) U.S. Cl. 711/162; 711/E12.103

(57) ABSTRACT

A data recovery apparatus includes accepting unit configure to accept an instruction to recover data in a first storage device, generating unit configure to generate difference information describing differences between backup data backed up from the first storage device to a second storage device and data stored in the first storage device at the point in time when the data recovery instruction has been received by the accepting unit; and updating unit configure to update data stored in the first storage device on the basis of the difference information generated by the generating unit and the backup data.

### CROSS REFERENCE TO RELATED APPLICATION

This application is based upon and claims the benefit of priority from the prior Japanese Patent Application NO. 2010-183435 filed on Aug. 18, 2010, the entire contents of which are incorporated herein by reference.

### FIELD

The embodiments discussed herein are related to a data recovery apparatus, a data recovery method and a computer readable, non-transitory medium storing a data recovery program that recover data.

### BACKGROUND

Conventionally, data stored in storage devices such as hard disks and magnetic tapes are backed up in case of data loss caused by accidents such as data corruption or infection with a computer virus. In a backup technique, once a full backup has been made, differential backups of only the data updated since the full backup are taken in order to reduce backup time.

### PATENT DOCUMENT

Japanese Laid-Open Patent Publications No. 9-101912 and No. 2006-302015

However, the existing technique described above takes much time for data recovery because the recovery process is performed on whole backup data in a storage device during the data recovery even if only part of the data in the storage device has been lost.

### SUMMARY

According to one aspect of the embodiments, there is provided a data recovery apparatus includes: accepting unit configure to accept an instruction to recover data stored in a first storage device; generating unit configure to generate difference information describing differences between backup data backed up from the first storage device to a second storage device and data stored in the first storage device at the point in time when the data recovery instruction has been accepted; and updating unit configure to update the data stored in the first storage device on the basis of the generated difference information and the backup data.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram illustrating an example of a data recovery process according to an embodiment;

FIG. 2 is a block diagram illustrating a hardware configuration of the data recovery apparatus according to the embodiment;

FIG. 3 is a block diagram illustrating a functional configuration of the data recovery apparatus according to the embodiment;

FIG. 4 is a flowchart illustrating an example of a data recovery procedure performed by the data recovery apparatus according to the embodiment;

FIG. 5 is a diagram illustrating an example of a storage system according to the embodiment;

FIG. 6 is a diagram illustrating an example of a backup process performed by the storage system;

FIG. 7 is a diagram illustrating a specific example of a backup list;

FIG. 8 is a diagram illustrating a specific example of a differential backup list;

FIG. 9 is a diagram illustrating an example of a restore process performed by the storage system;

FIG. 10 is a diagram illustrating a specific example of a differential restore list;

FIG. 11 is a diagram illustrating an example of data stored in a second storage device;

FIG. 12 is a diagram illustrating a specific example of a backup data selection screen;

FIG. 13 is a diagram illustrating a specific example of a difference file selection screen;

FIG. 14 is a flowchart illustrating an example of a backup procedure performed by a server;

FIG. 15 is a flowchart illustrating an example of a detailed procedure for generating a differential backup list;

FIG. 16 is a flowchart illustrating an example of a restore procedure performed by the server; and

FIG. 17 is a flowchart illustrating a specific example of a procedure for generating a differential restore list.

### DESCRIPTION OF EMBODIMENTS

Embodiments of a data recovery apparatus, a data recovery method and a data recovery program according to the present invention will be described below with reference to the accompanying drawings.

### (Embodiment of Data Recovery Process)

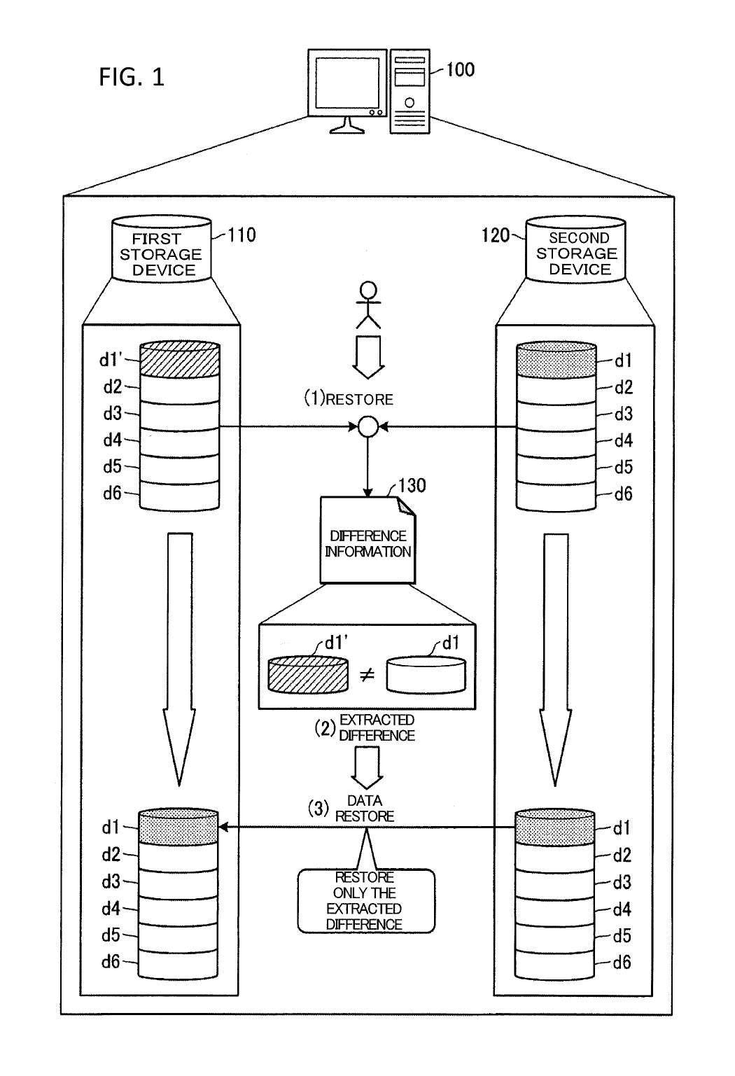

FIG. 1 is a diagram illustrating an example of a data recovery process according to an embodiment. A data recovery apparatus 100 in FIG. 1 is a computer which executes data recovery process for a first storage device 110. The first storage device 110 is a storage device storing data to be backed up and restored. The second storage device 120 is a storage device that stores a backup of data from the first storage device 110.

The first and second storage devices 110 and 120 may be hard disks, flash memories, or magnetic tapes, for example. The first and second storage devices 110 and 120 may be included in the data recovery apparatus 100 or may be included in another computer (not depicted) capable of communicating with the data recovery apparatus 100.

The term “backup” as used herein refers to saving a duplicate copy (backup data) of data beforehand in case of an accident such as data loss. The term “restore” as used herein refers to recovering lost data with backup data in the event of data loss. Data to be backed up and restored may be a file, a folder, an application, or an operating system (OS), for example.

Possible causes of data loss include hardware failure, deletion of a file by a human error, and tampering of data by a computer virus, among others. Depending on circumstances, not all of backup data needs to be restored but only part of the backup data needs to be restored during restoration of the first storage device 110.

For example, if a file is deleted by a human error or data is tampered with by a computer virus, only the file deleted or the data tampered with need to be restored. Therefore, according to the present embodiment, when a restore is performed, differences between data stored in the first storage device 110 and backup data stored in the second storage device 120 are extracted and only the extracted differences are restored.

An example of a data recovery process performed by the data recovery apparatus 100 will be described below. Data stored in the first storage device 110 is referred to as “data d1′, d2-d6” and backup data stored in the second storage device 120 is referred to as “data d1-d6”.

(1) The data recovery apparatus 100 accepts an instruction to restore the first storage device 110. Here, the restore instruction is a data recovery instruction to recover data stored in the first storage device 110.

(2) The data recovery apparatus 100 generates difference information 130 representing differences between the data stored in the first storage device 110 at the time of acceptance of the restore instruction and backup data stored in the second storage device 120. The difference information 130 may be information representing a file, a folder, an application, or an OS, for example, in the first storage device 110 that has been changed, added, or deleted since a backup.

Specifically, the data recovery apparatus 100 compares data d1′, d2-d6 stored in the first storage device 110 with data d1-d6 stored in the second storage device 120, for example, to generate difference information 130. In the example in FIG. 1, difference information 130 representing that data d1′ stored in the first storage device 110 differs from data d1 stored in the second storage device 120 is generated.

(3) The data recovery apparatus 100 updates the data in the first storage device 110 on the basis of the generated difference information 130 and the backup data stored in the second storage device 120. Specifically, the data recovery apparatus 100 changes, adds, or delete, for example, data in the first storage device 110 that is identified from the difference information 130.

In the example in FIG. 1, data d1′ stored in the first storage device 110 is deleted and data d1 is written from the second storage device 120 to the first storage device 110. As a result, the first storage device 110 will contain the same data as the second storage device 120.

In this way, according to the present embodiment, when the first storage device 110 is restored, differences between the data stored in the first storage device 110 and the backup data stored in the second storage device 120 are extracted and the restore is limited to only the extracted differences. Thus, the amount of data to be restored is reduced and therefore the restore requests less processing time than restoring whole backup data d1-d6.

### (Hardware Configuration of Data Recovery Apparatus 100)

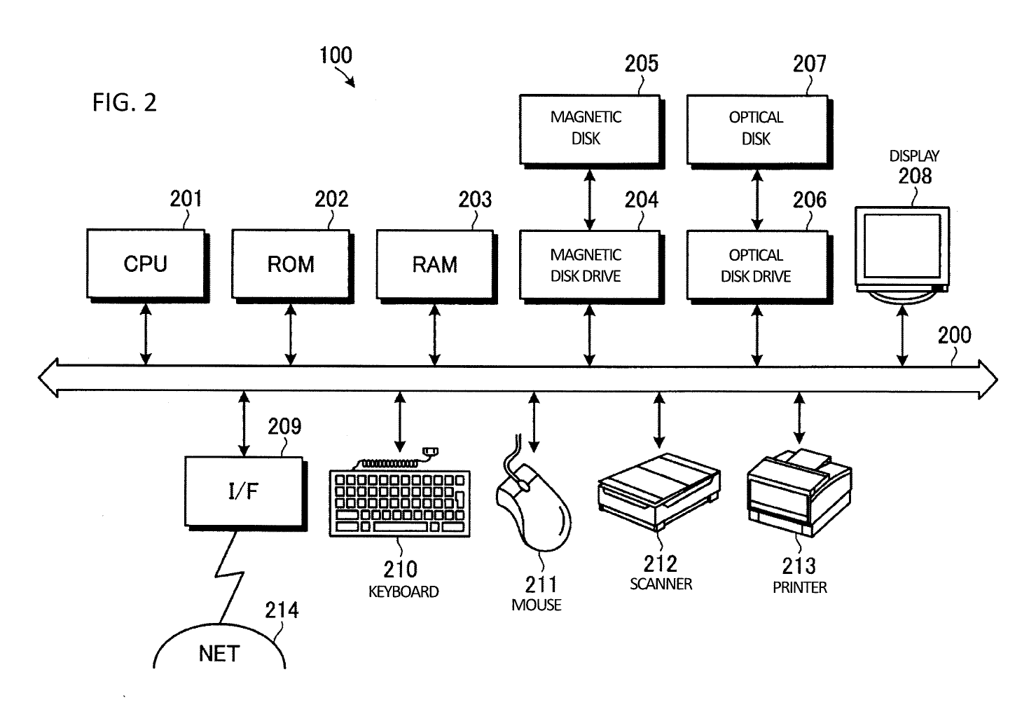

FIG. 2 is a block diagram illustrating a hardware configuration of the data recovery apparatus according to the present embodiment. The data recovery apparatus 100 in FIG. 2 includes a central processing unit (CPU) 201, a read-only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213. The components are interconnected through a bus 200.

The CPU 201 is responsible for controlling the entire data recovery apparatus 100. The ROM 202 stores programs such as a boot program. The RAM 203 is used by the CPU 201 as a work area. The magnetic disk drive 204 controls read and write of data on the magnetic disk 205 under the control of the CPU 201. The magnetic disk 205 stores data written under the control of the magnetic disk drive 204.

The optical disk drive 206 controls read and write of data on the optical disk 207 under the control of the CPU 201. The optical disk 207 stores data written under the control of the optical disk drive 206 and allows a computer to read data stored in the optical disk 207.

The display 208 displays text, images and functional information, such as cursors, icons, and toolboxes. The display 208 may be a CRT, a TFT liquid-crystal display, or a plasma display, for example.

The I/F 209 is connected onto a network 214 such as a local area network (LAN), a wide area network (WAN), or the Internet through a communication line and connected to external devices through the network 214. The I/F 209 is responsible for interfacing between the network 214 and the internal components of the data recovery apparatus 100 and controls input and output of data to external devices. The I/F 209 may be a modem or a LAN adapter, for example.

The keyboard 210 includes keys for inputting characters, numbers, and instructions. A touch-sensitive input pad or a ten-key numeric keypad may be used instead of or in addition to the keyboard 210. The mouse 211 is used for moving a cursor, selecting a range of text, scrolling and resizing a window, and other operations. Any other pointing device that has a similar function, such as a trackball or a joystick, may be used.

The scanner 212 optically scans an image and captures image data into the data recovery apparatus 100. The scanner 212 may have the function of an optical character reader (OCR). The printer 213 prints image data and text data. The printer 213 may be a laser printer or an inkjet printer, for example. Some of the components 201 to 213 (for example the scanner 212 and printer 213) may be omitted from the data recovery apparatus 100.

### (Functional Configuration of Data Recovery Apparatus 100)

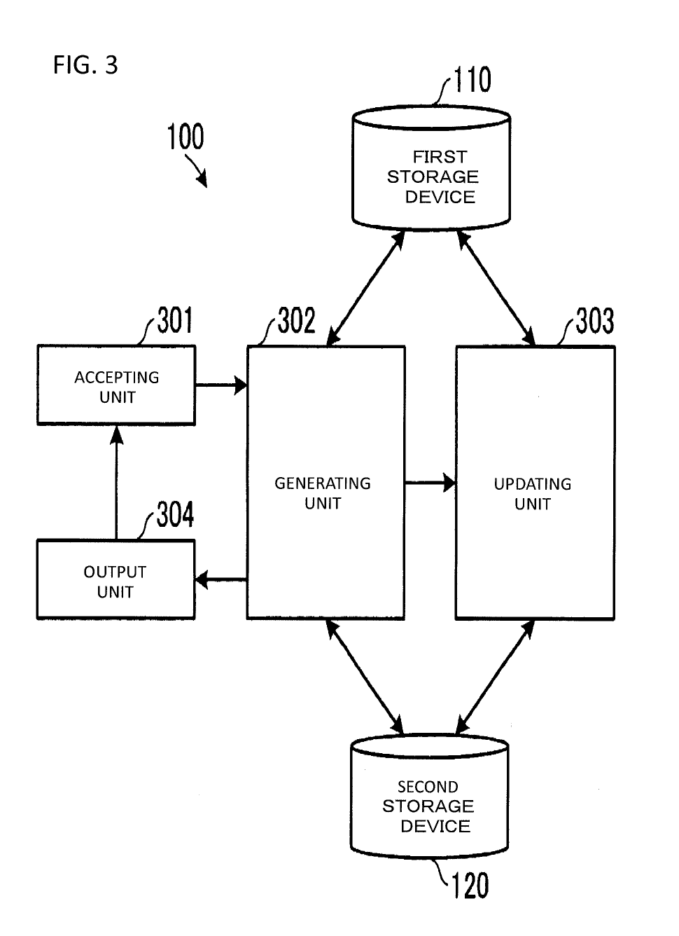

FIG. 3 is a block diagram illustrating a functional configuration of the data recovery apparatus according to the present embodiment. The data recovery apparatus 100 in FIG. 3 includes an accepting unit 301, a generating unit 302, an updating unit 303, and an output unit 304. The functions of the functional units (the accepting unit 301, generating unit 302, updating unit 303 and output unit 304) are implemented by causing the CPU 201 to execute a program stored in a storage device such as the ROM 202, the RAM 203, the magnetic disk 205, or the optical disk 207 depicted in FIG. 2, or through the use of the I/F 209, for example. Results of processing by the functional units 301 to 304 may be stored in a storage device such as the RAM 203, the magnetic disk 205, or the optical disk 207.

The accepting unit 301 accepts a restore instruction which contains, for example, a device name and an address for identifying a device to be restored (the first storage device 110) and a device name and an address identifying a target device (the second storage device 120) to which backup data is to be sent.

Specifically, the accepting unit 301 accepts an instruction to restore the first storage device 110 input by a user through the use of the keyboard 210 or the mouse 211. The accepting unit 301 may receive an instruction to restore the first storage device 110 from another computer (not depicted) through the network 214 illustrated in FIG. 2.

The generating unit 302 generates difference information describing differences between backup data stored in the second storage device 120 and data stored in the first storage device 110 at the point in time when a restore instruction has been accepted. The backup data stored in the second storage device 120 is the data stored in the first storage device 110 that was backed up before the acceptance of the restore instruction.

In the following description, data stored in the first storage device 110 at the point in time when a restore instruction has been accepted is referred to as a “first data set” and backup data stored in the second storage device 120 is referred to as a “second data set”.

Specifically, the generating unit 302 compares a first data set in the first storage device 110 with a second data set in the second storage device 120, for example. The generating unit 302 then generates difference information describing differences between the first data set and the second data set. The differences may be the following data (i) to (iii), for example.

(i) Data that is included in both of the first and second data sets and differs from each other (referred to as “difference data X”).

(ii) Data that is included only in the second data set out of the first and second data sets (referred to as “difference data Y”).

(iii) Data that is included only in the first data set out of the first and second sets of data (referred to as “difference data Z”).

The updating unit 303 updates the first data set stored in the first storage device 110 on the basis of the generated difference information and the second data set stored in the second storage device 120. Specifically, if the difference data identified from difference information is data (i) described above, the updating unit 303 writes difference data X from the second storage device 120 to the first storage device 110. As a result, the difference data X in the first storage device 110 is updated with the difference data X in the second storage device 120.

If the difference data identified from difference information is data (ii) described above, the updating unit 303 writes difference data Y from the second storage device 120 to the first storage device 110. As a result, the difference data Y is added to the first storage device 110. If difference data identified from difference information is data (iii) described above, the updating unit 303 deletes difference data Z from the first storage device 110.

The output unit 304 outputs generated difference information. The output unit 304 may output the information to the display 208 or to the printer 213 or send to an external device through the I/F 209. The output unit 304 may store the difference information in a storage area on a storage device such as the RAM 203, the magnetic disk 205, or the optical disk 207.

Some difference data identified from difference information does not need to be recovered. For example, data intentionally deleted, added or changed by a user does not need to be recovered. Therefore, before the updating unit 303 starts updating, the difference data identified from difference information may be presented to the user to allow the user to select difference data to recover.

For example, the output unit 304 may display a selection screen on which the user may select difference data to recover out of difference data identified from difference information on the display 208. In this case, the accepting unit 301 accepts a selection of difference data made by the user from the difference data displayed on the selection screen through an input operation with the keyboard 210 or the mouse 211.

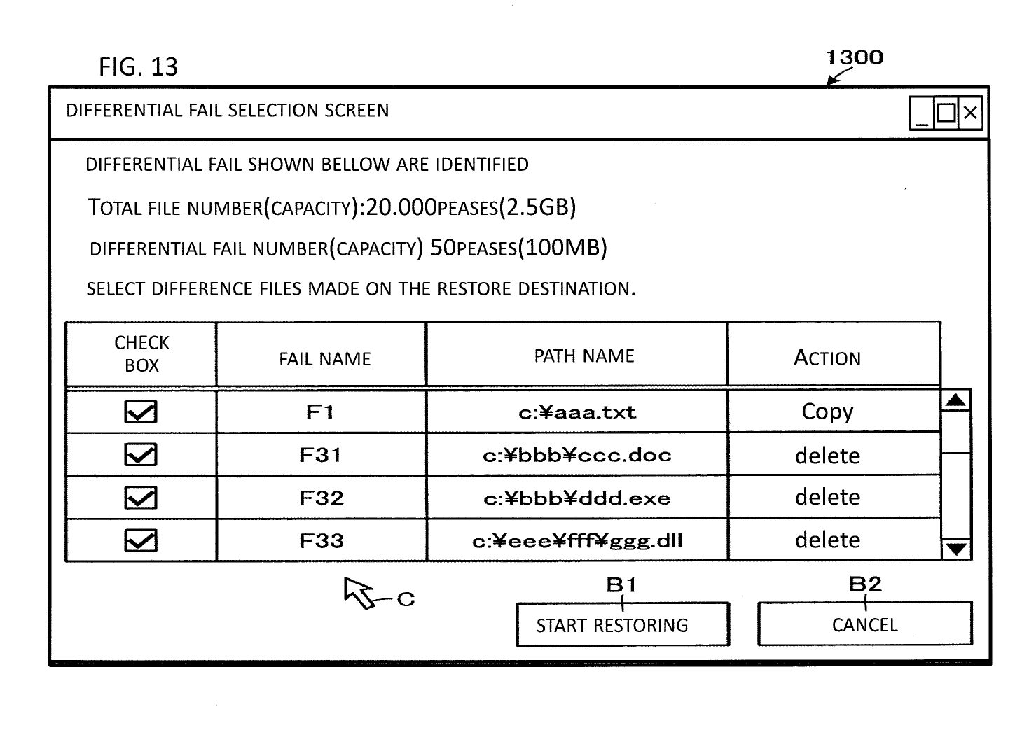

The updating unit 303 then updates the first data set in the first storage device 110 on the basis of the difference data that has been selected. Thus, only the desired difference data out of the difference data identified from difference information may be selectively restored. A specific example of the selection screen allowing the user to select difference data to recover will be described later with reference to FIG. 13.

### (Data Recovery Procedure by Data Recovery Apparatus 100)

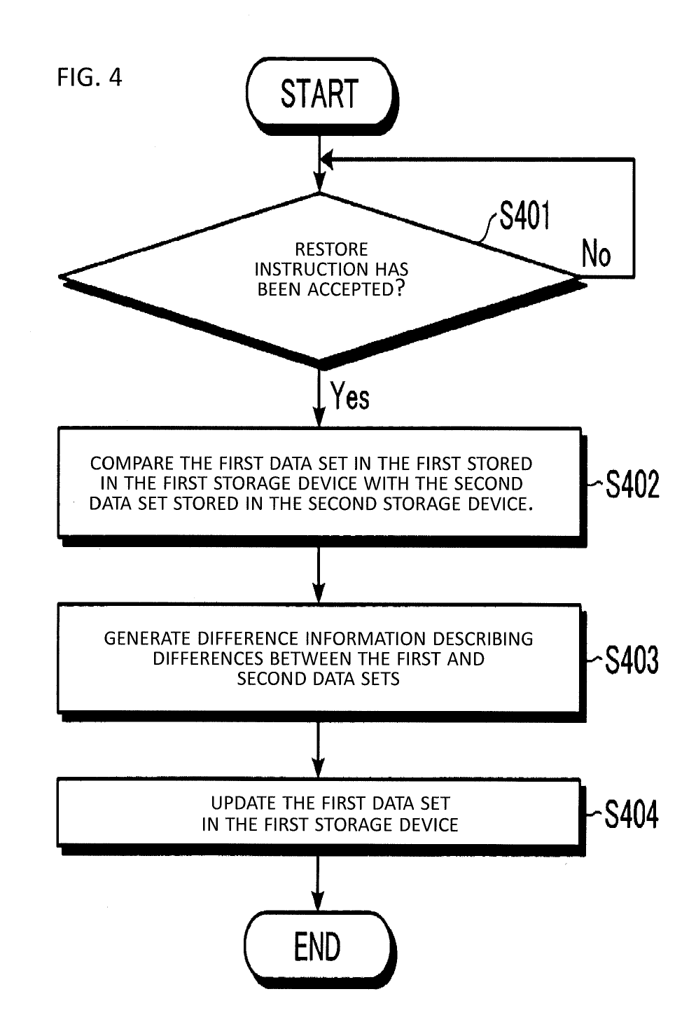

FIG. 4 is a flowchart illustrating an example of a data recovery procedure performed by the data recovery apparatus according to the present embodiment. In the flowchart of FIG. 4, first, determination is made as to whether or not the accepting unit 301 has accepted an instruction to restore the first storage device 110 (step S401).

If the accepting unit 301 has not been accepted a restore instruction (No at step S401), the process waits for a restore instruction. When a restore instruction has been accepted (Yes at step S401), the generating unit 302 compares the first data set stored in the first storage device 110 at the point in time when the restore instruction has bee accepted with the second data set stored in the second storage device 120 (step S402).

The generating unit 302 then generates difference information describing differences between the first and second data sets (step S403). The updating unit 303 updates the first data set in the first storage device 110 on the basis of the generated difference information and the second data set in the second storage device 120 (step S404). Then the process of the flowchart will end.

The data recovery apparatus 100 described above is capable of extracting differences between data in the first storage device 110 and backup data in the second storage device 120 during a restore operation of the first storage device 110 and limiting the restore to only the extracted differences. Accordingly, the amount of data to be restored is reduced and therefore the processing time requested for the restore may be reduced when compared with a restore of whole backup data.

### (Example of Storage System 500)

An example will be described in which the data recovery apparatus 100 according to the present embodiment is applied to a server 501 in a storage system 500. The server 501 includes the accepting unit 301, the generating unit 302, the updating unit 303 and the output unit 304 of the data recovery apparatus 100 described above.

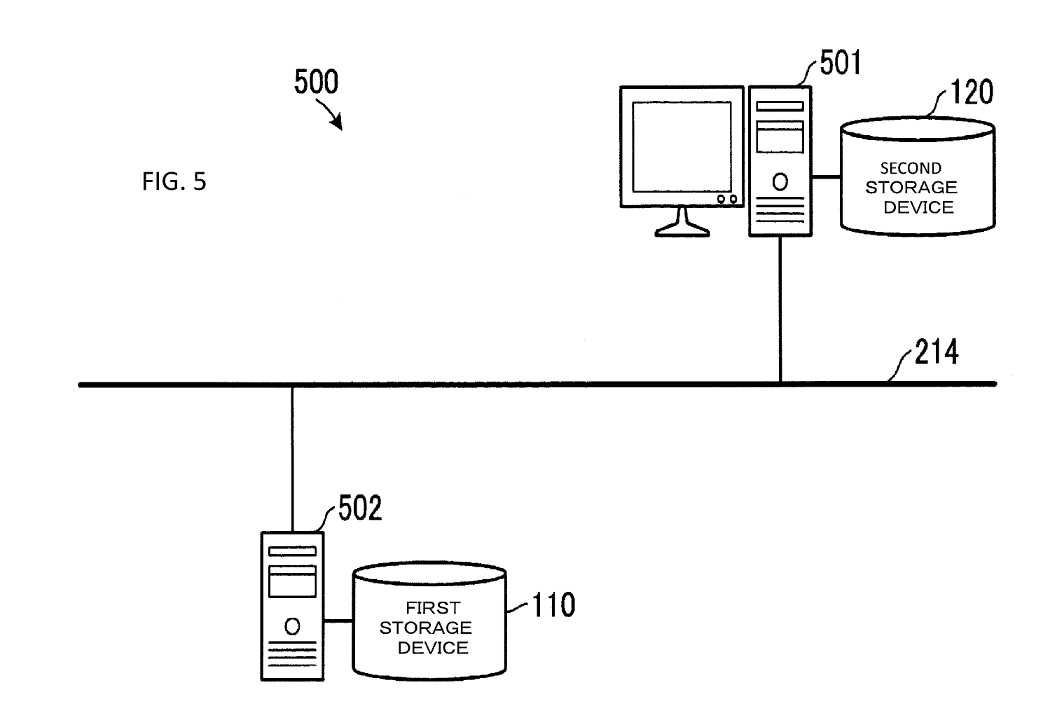

FIG. 5 is a diagram illustrating the exemplary storage system according to the present embodiment. The storage system 500 in FIG. 5 includes the server 501 and an information processor 502. The server 501 and the information processor 502 in the storage system 500 are interconnected through a network 214 such as the Internet, a LAN, or a WAN.

The server 501 is a computer that controls the information processor 502 to perform backup and restore of a first storage device 110. The server 501 includes a second storage device 120 storing backup data for the first storage device 110. The server 501 may be a deployment server which provides and deploys data used through the network 214 to make the data available to users.

The information processor 502 is a computer including the first storage device 110 to be backed up and restored. The information processor 502 may be a database server, a Web server or a personal computer (PC). The server 501 and the information processor 502 may be implemented with the hardware configuration illustrated in FIG. 2, for example.

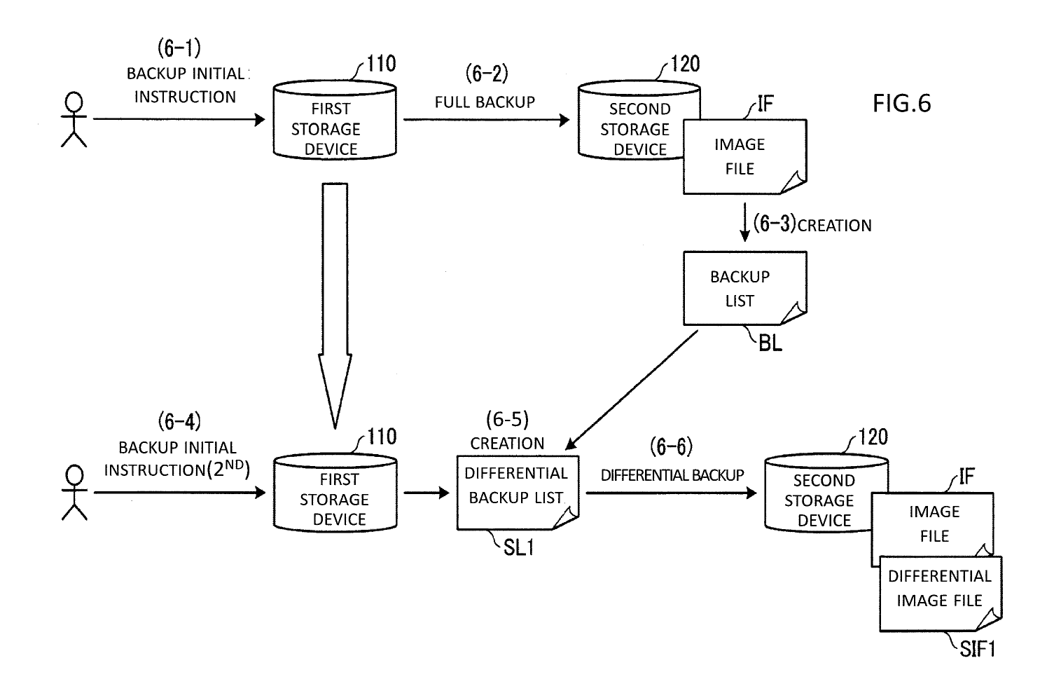

A backup process and a restore process performed in the storage system 500 according to the present embodiment will be described with reference to FIGS. 6 to 10. The backup and restore processes will be described with respect to files, which is an example of data to be backed up and restored.

### (Backup Process in Storage System 500)

FIG. 6 is a diagram illustrating an example of the backup process performed in the storage system 500. (6-1) The server 501 accepts an (initial) instruction to back up the first storage device 110 in FIG. 6. Specifically, the server 501 accepts an instruction to back up the first storage device 110 input by a user with the keyboard 210 or the mouse 211, for example.

(6-2) Upon accepting the (initial) backup instruction, the server 501 performs a full backup of the first storage device. The full backup here means to take a backup of all files that are stored in the first storage device 110 at a time.

Specifically, the server 501 stores files stored in the first storage device 110 at the point in time when an (initial) backup instruction has been received into the second storage device 120 as an image file IF through the network 214, for example. The image file IF is a copy of data in the first storage device 110 that replicates files and folder structures of the data as well.

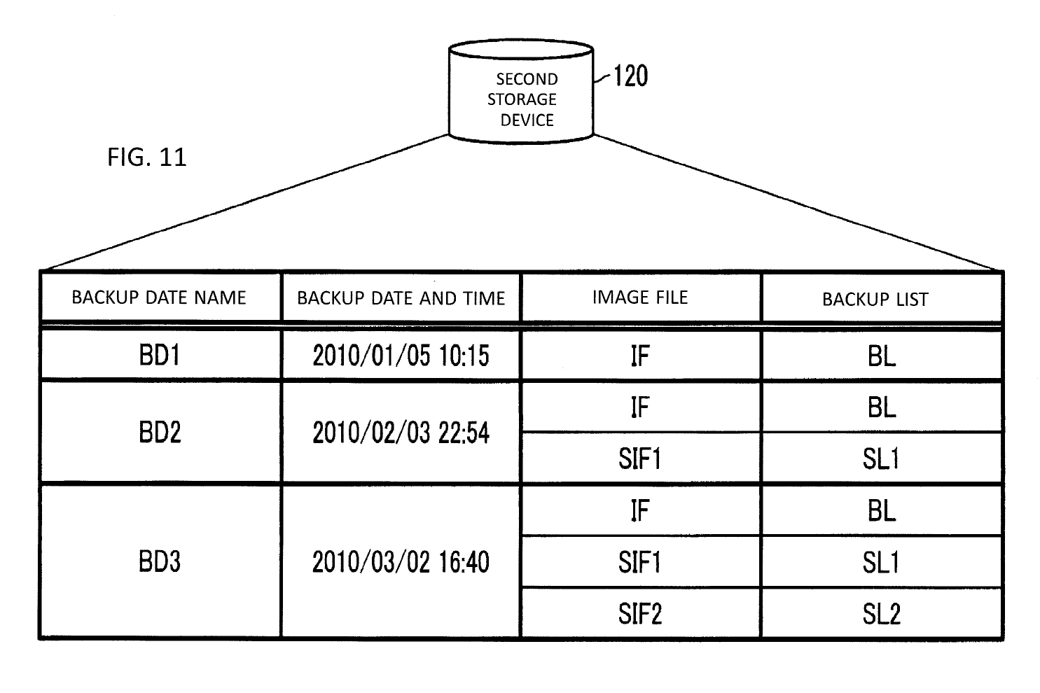

(6-3) The server 501 generates a backup list BL of the files contained in the image file IF. The generated backup list BL is associated and stored with the image file IF in the second storage device 120 (see FIG. 11, which will be described later). An example of the backup list BL will be described below.

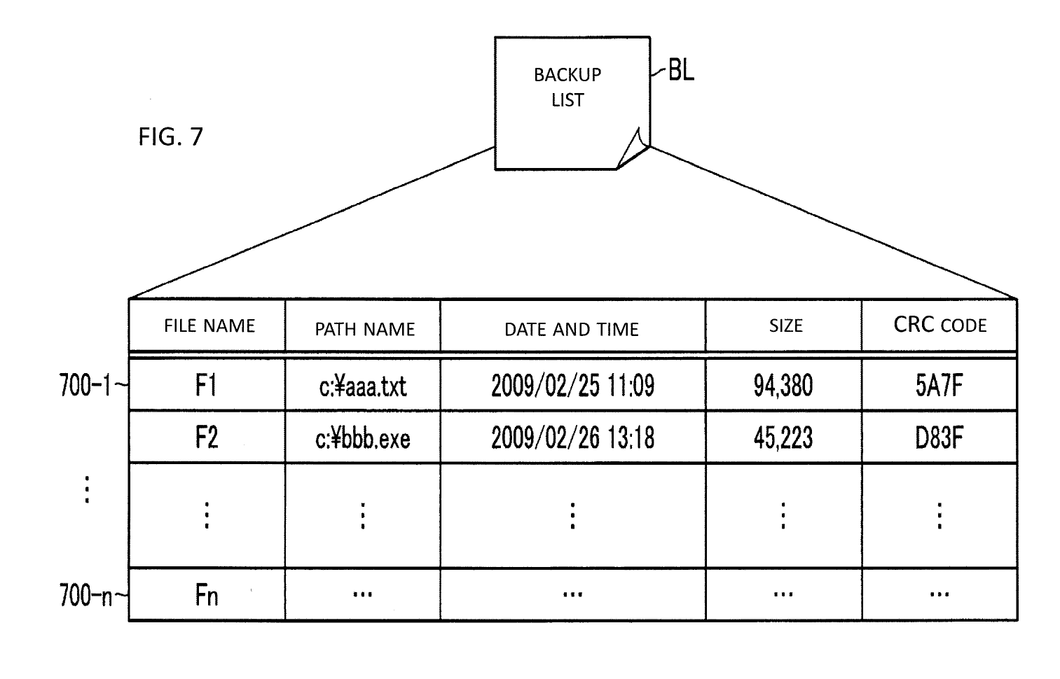

FIG. 7 is a diagram illustrating the exemplary backup list. The backup list BL in FIG. 7 contains file name, path name, date and time, size and cyclic redundancy check (CRC) code fields. Entries of file information 700-1 to 700-n set in the fields are stored as records.

The file names are identifiers of the files Fi (i=1, 2, . . . , n) that are used herein for purposes of illustration. The path names are file paths indicating the storage locations of the files Fi in the first storage device 110. The dates and times are the update dates and times of the files Fi. The sizes are the amounts of data (in bytes) in the files Fi.

The CRC codes are redundancy codes that are generated from the data in the files Fi and are unique to the files Fi. The same CRC code is generated from the same data. Even if only 1 byte of data differs, a different code is generated. Accordingly, whether files are the same or not may be determined by comparing the CRC codes of the files.

For file information 700-1, for example, the path name “c:\aaa.txt” of the file F1, the date and time “2009/02/25 11:09”, the size “94,380”, and the CRC code “5A7F” are stored.

Returning to FIG. 6, the description of the backup process will be continued. It is assumed here that any of the files stored in the first storage device 110 has been changed or deleted after the first backup described above. Then a second backup of the first storage device 110 is performed by following the procedure (6-4) to (6-6) described below.

(6-4) The server 501 accepts a (second) instruction to back up the first storage device 110. (6-5) In response to the (second) backup instruction, the server 501 refers to the backup list BL generated in (6-3) to generate a differential backup list SL1.

A differential backup is a backup of only data changed or added since the last backup. Accordingly, the differential backup list SL1 contains information describing difference files between the files stored in the first storage device 110 at the point in time when the (second) backup instruction has been accepted and the files on the backup list BL.

The generated differential backup list SL1 is associated and stored with the backup list BL in the second storage device 120 (see FIG. 11, which will be described later). An example of the differential backup list SL1 will be described below.

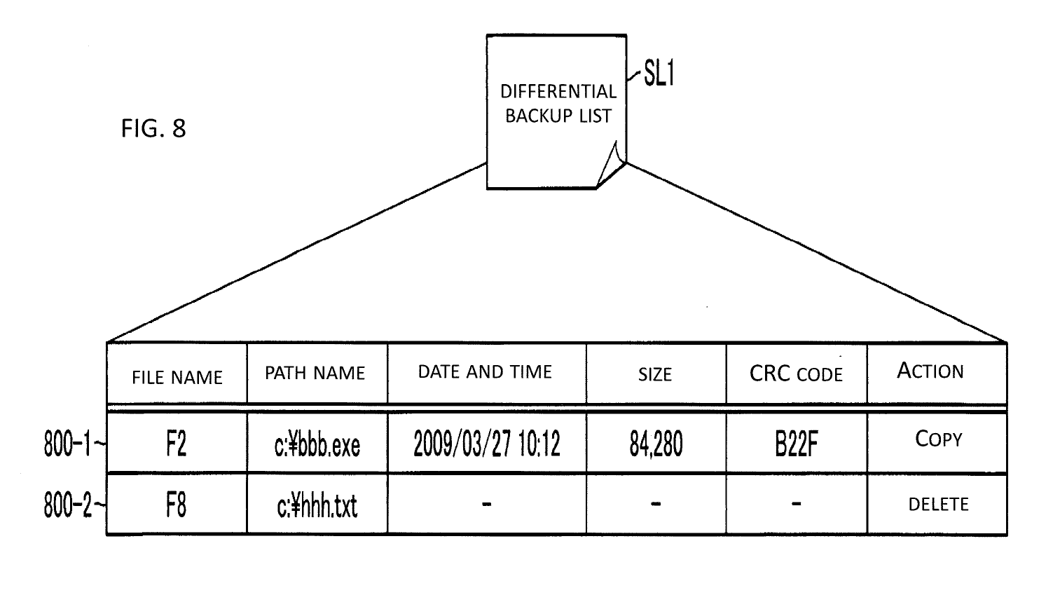

FIG. 8 is a diagram illustrating an example of the differential backup list SL1. The differential backup list SL1 in FIG. 8 contains file name, path name, date and time, size, CRC code and action fields. Entries of difference file information 800-1 and 800-2 set in the fields are stored as records.

The file names are identifiers of the files Fi. The path names are file paths indicating the storage locations of the files Fi in the first storage device 110. The dates and times are the update dates and times of the files Fi. The sizes are the amounts of data (in bytes) in the files Fi. The CRC codes are redundancy codes that are generated from the data in the files Fi and are unique to the files Fi.

The actions are actions on the files Fi in the backup destination, namely the second storage device 120. For example, if a file Fi is stored in the first storage devices 110 and the second storage device 120 but contains different data, the action will be “Copy”.

If the file Fi is stored only in the second storage device 120 out of the first and second storage devices 110 and 120, the action will be “Delete”. If the file Fi is stored only in the first storage device 110 out of the first and second storage devices 110 and 120, the action will be “Copy”.

For difference file information 800-1, for example, the path name “c:\bbb.txt” of the file F2, the date and time “2009/03/27 10:12”, the size “84,280”, the CRC code “B22F”, and the action “Copy” are stored.

Referring back to FIG. 6, (6-6) the server 501 refers to the generated differential backup list SL1 to perform a differential backup of the first storage device 110. In the example of the differential backup list SL1 illustrated in FIG. 8, the server 501 stores a file F2 from the first storage device 110 to the second storage device 120 as a difference image file SIF1. In doing this, the server 501 associates and stores the differential image file SIF1 with the image file IF in the second storage device 120 (see FIG. 11, which will be described later).

When a third and subsequent backups are performed, the server 501 merges the backup list BL with the differential backup list SL1, for example, to generate a new backup list BL in (6-5) described above. The merge means to update the backup list BL according to the actions on each file on the differential backup list SL1.

In the example of the backup list BL in FIG. 7 and the differential backup list SL1 in FIG. 8, the update date and time, size, and CRC code of the file F2 on the differential backup list SL1 are written in their respective fields of the file F2 on the backup list BL. The record of the file F8 is deleted from the differential backup list BL.

The server 501 then refers to the new backup list BL to generate a differential backup list SL2. The differential backup list SL2 contains information describing difference files between the files stored in the first storage device 110 at the point in time when the (third) backup instruction has been accepted and the files on the new backup list BL.

### (Restore Process in Storage System 500)

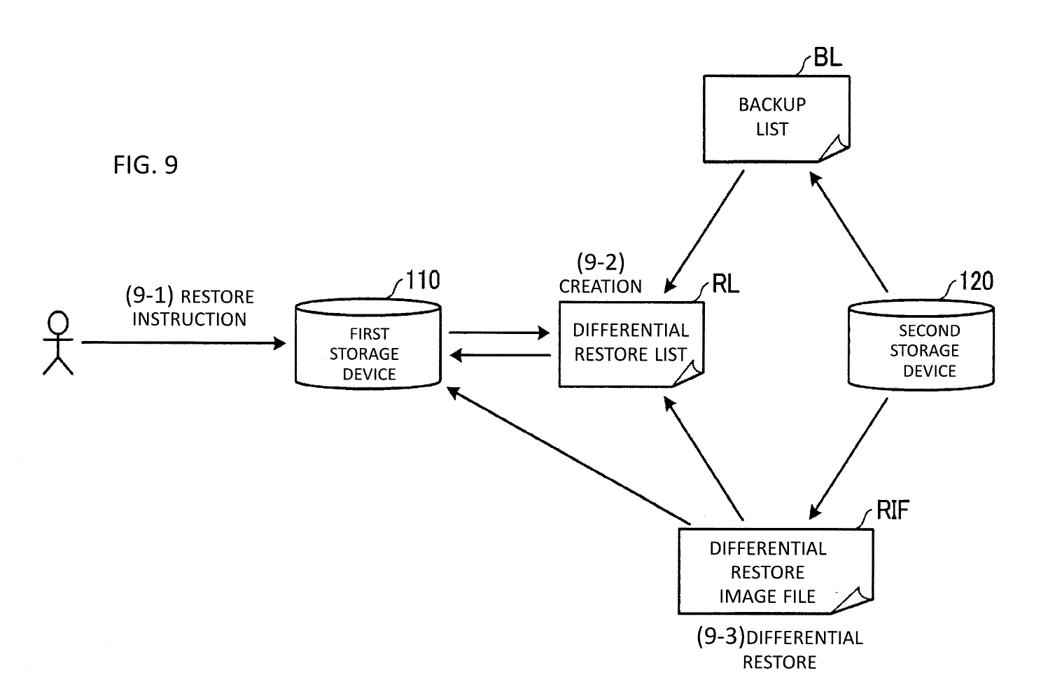

FIG. 9 is a diagram illustrating an example of a restore process performed in the storage system. The restore process described here is performed at the second backup process illustrated in FIG. 6.

In FIG. 9, (9-1) the server 501 accepts an instruction to restore the first storage device 110. (9-2) In response to the restore instruction, the server 501 refers to the backup list BL to generate a differential restore list RL for the first storage device 110.

The differential restore list RL contains difference information describing difference files between the files stored in the first storage device 110 at the point in time when the restore instruction has been accepted and the files on the backup list BL. The backup list BL referred to in (9-2) is a merge of the backup list BL illustrated in FIG. 7 and the differential backup list SL1 illustrated in FIG. 8. An exemplary differential restore list RL will be described below.

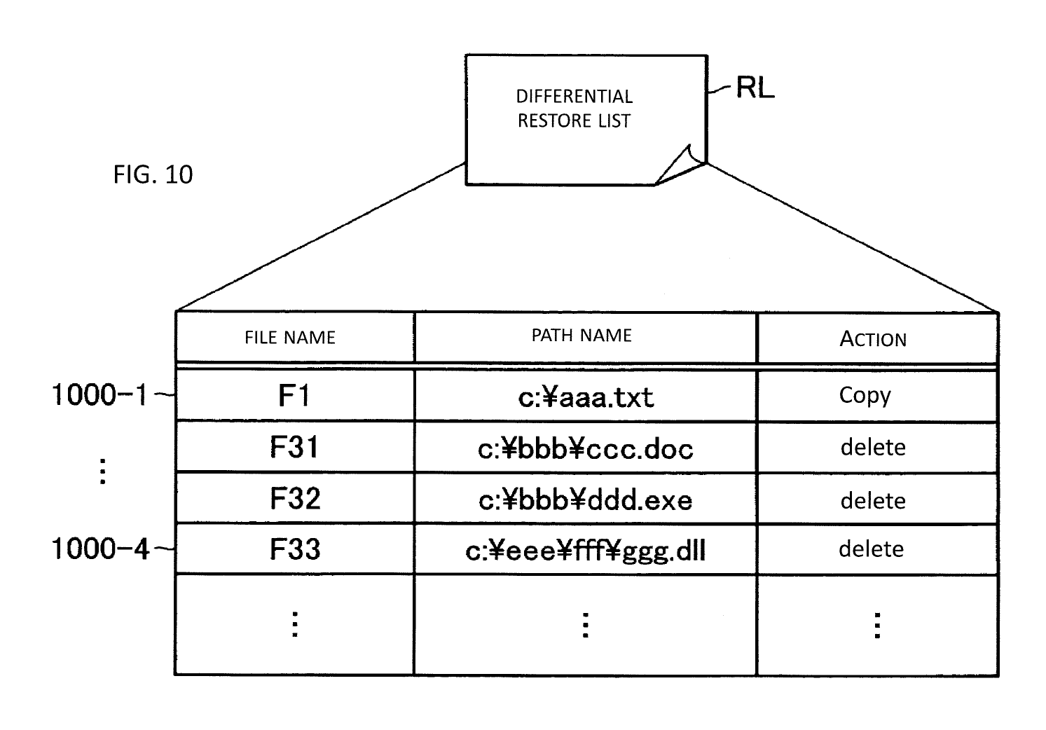

FIG. 10 is a diagram illustrating the exemplary differential restore list. The differential restore list RL in FIG. 10 contains file name, path name and action fields. Entries of difference file information (for example difference file information 1000-1 to 1000-4) set in the fields are stored as records.

The file names are identifiers of the files Fi. The actions are actions on the files Fi in the restore destination, namely the first storage device 110. For example, if a file Fi is stored in the first storage devices 110 and the second storage device 120 but contains different data, the action will be “Copy”.

If the file Fi is stored only in the second storage device 120 out of the first and second storage devices 110 and 120, the action will be “Copy”. If the file Fi is stored only in the first storage device 110 out of the first and second storage devices 110 and 120, the action will be “Delete”.

For difference file information 1000-1, for example, the path name “c:\aaa.txt” of the file F1 and the action “Copy” are contained. For the difference file information 1000-2, the path name “c:\bbb\ccc.doc” of the file F31 and the action “Delete” are contained.

Referring back to FIG. 9, (9-3) the server 501 refers to the generated differential restore list RL to perform a differential restore of the first storage device 110. Specifically, the server 501 refers to the differential restore list RL, extracts a file for which action “Copy” is set from the second storage device 120, and generates a differential restore image file RIF.

The server 501 refers to the differential restore list RL, deletes a file for which action “Delete” is set from the first storage device 110, and copies a file from the generated differential restore image file RIF to the first storage device 110. While a differential restore of the first storage device 110 has been descried with respect to FIG. 9, the server 501 may allow a user to choose full restore or differential restore.

### (Data Stored in Second Storage Device 120)

Data stored in the second storage device 120 will be described below. Since data in the first storage device 110 is updated as needed, generally a backup of the first storage device 110 is made at regular intervals (for example weakly or monthly). The second storage device 120 may store the data backed up from the first storage device that are organized by their respective backup date and time. Data stored in the second storage device 120 will be described below.

FIG. 11 is a diagram illustrating an example of data stored in the second storage device. The second storage device 120 in FIG. 11 stores a backup date and time, an image file and a backup list for each piece of backup data BD1 to BD3.

The backup data names are the identifiers of backup data. The backup dates and times are information indicating the times at which backups of the first storage have been taken. The image files are image files or difference image files generated during the backups. The backup lists are backup lists or differential backup lists generated during the backups.

For backup data BD1, for example, the backup date and time “2010/01/05/10:15”, the image file “IF” and the backup list “BL” are stored. For backup data BD2, for example, the backup date and time “2010/02/03 22:54”, image files “IF” and “SIF1”, and the backup lists “BL” and “SL1” are stored.

Before starting a restore process for the first storage device 110, the server 501 may present backup data BD1 to BD3 to the user to allow the user to select backup data to recover. A backup data selection screen for selecting backup data to recover will be described below.

### (Backup Data Selection Screen)

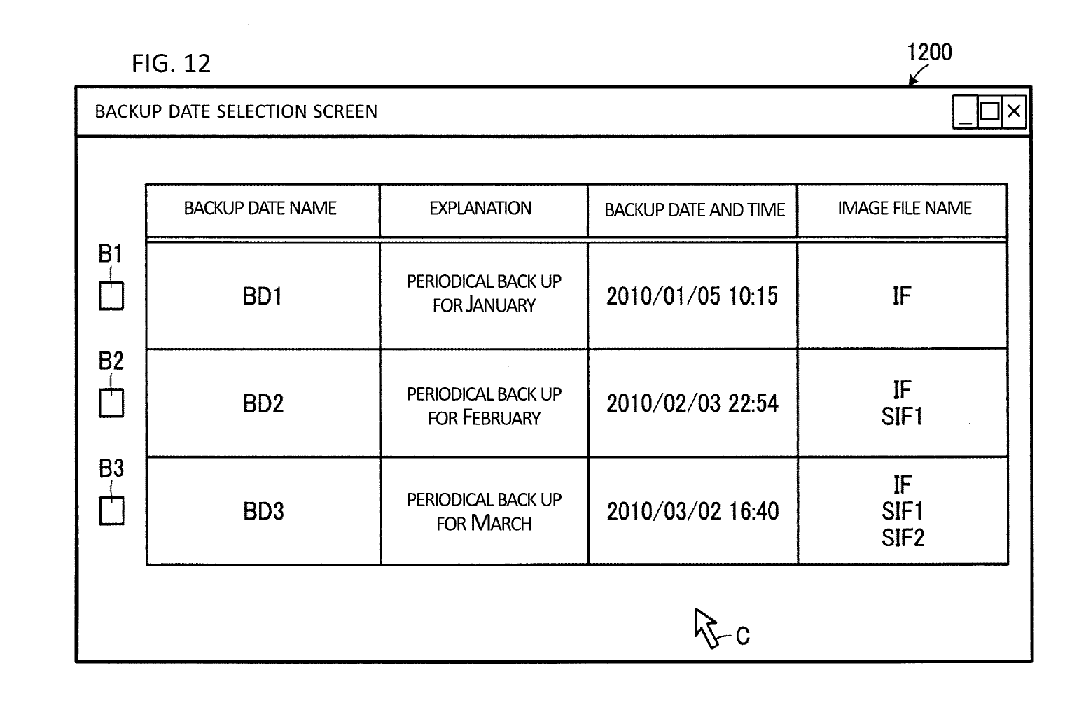

FIG. 12 is a diagram illustrating an exemplary backup data selection screen. The backup data name, description, backup date and time, and image file name of each piece of backup data BD1 to BD3 are displayed on the backup data selection screen 1200 in FIG. 12.

The backup data names are the identifiers of the backup data. The descriptions describe the periods of time covered by the backups. The backup dates and times are information indicating the times at which the backups of the first storage device 110 have been performed. The image file names are the names of image files and difference image files generated during the backups.

The backup data selection screen 1200 also includes buttons B1 to B3 for selecting backup data to recover from among the backup data BD1 to BD3. On the backup data selection screen 1200, the user may move a cursor C to click on any of the buttons B1 to B3 with the keyboard 210 and/or the mouse 211 to select backup data to recover.

For example, if backup data BD1 is selected on the backup data selection screen 1200, the server 501 refers to the backup list BL of the backup data BD1 and generates a differential restore list RL for the first storage device 110 in (9-2) in FIG. 9.

In this way, any backup data to restore may be selected from among the pieces of backup data BD1 to BD3 taken at different backup times. Thus, the data in the first storage device 110 may recovered to any point in time at which a backup has been performed.

### (Difference File Selection Screen)

A difference file selection screen for selecting a difference file to recover from among difference files identified from the differential restore list RL before starting the restore process will be described below.

As stated earlier, some of the difference files identified from the differential restore list RL, such as those that have been intentionally deleted, added or changed by a user, do not need to be recovered. Therefore, before starting the restore process, a difference file selection screen is displayed on the display 208 of the server 501 to allow a user to select a difference file to recover.

FIG. 13 is a diagram illustrating an example of the difference file selection screen. The total number (size) of files that may be backed up, and the number (size) of difference files identified from the differential restore list RL are displayed on the difference file selection screen 1300. This information allows the user to determine the ratio of the numbers of the difference files to the total number of the files.

Also displayed on the difference file selection screen 1300 is a list of difference files identified from the differential restore list RL. Specifically, a checkbox, a file name, a path name and an action for each difference file are displayed. The file names are the identifier of the difference file.

The path names represent the file paths indicating the storage locations of the files Fi in the first storage device 110. The actions are actions relating to the difference files made on the restore destination, namely the first storage device 110. The check boxes are used for selecting difference files to recover. Each of the check boxes contains a checkmark by default.

On the difference file selection screen 1300, the checkmark in the checkbox of any of the difference files may be cleared to exclude the difference file from the restore by moving a cursor C to the checkbox and clicking on the checkbox. In this way, the user is allowed to select difference files to recover from among the difference files identified from the differential restore list RL. Thus, the user may exclude files that do not need to be recovered, such as the files that the user intentionally deleted, added or changed.

The restore process may be initiated by moving the cursor C to a restore start button B1 and clicking on the restore start button B1 on the difference file selection screen 1300. In this case, the restore process is performed on the difference files with checkmarks in the checkboxes among the difference files identified from the differential restore list RL.

Execution of the restore process may be canceled by moving the cursor C to a cancel button B2 and clicking on the cancel button B2 on the difference file selection screen 1300. Estimated processing time requested for the restore process may be displayed on the difference file selection screen 1300. The estimated processing time may be calculated by adding the sizes of the difference files having checkmarks in the checkboxes together and dividing the sum by the transfer rate of the network 214, for example.

### (Backup Procedure by the Server 501)

A backup procedure performed by the server 501 will be described below,

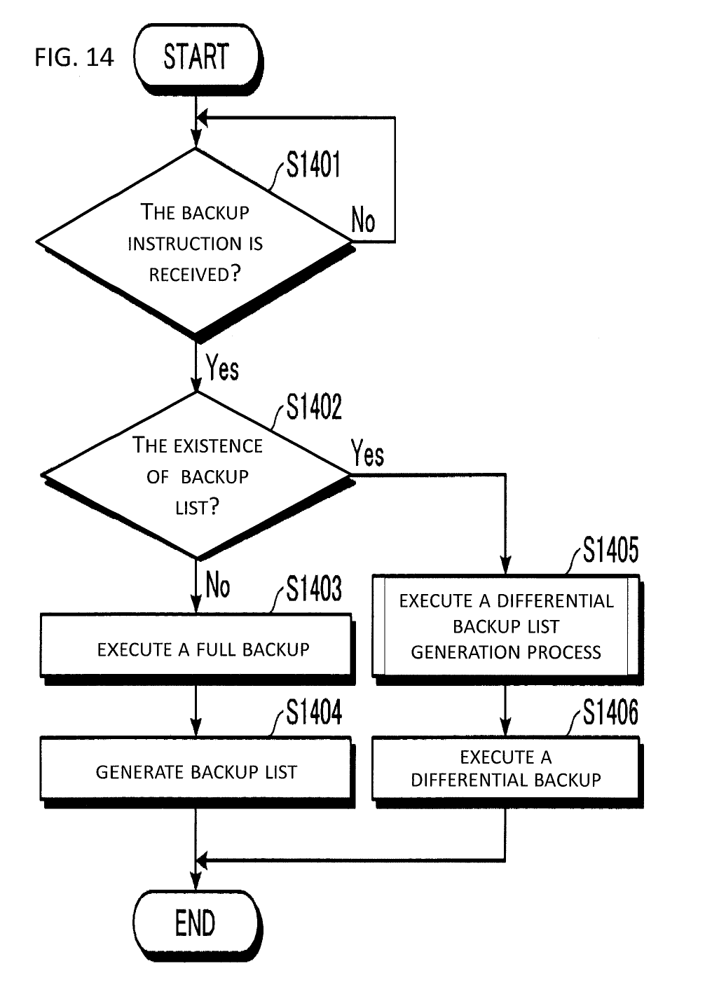

FIG. 14 is a flowchart illustrating an example of the backup procedure performed by the server. In the flowchart of FIG. 14, the server 501 first determines whether or not an instruction to make a backup of the first storage device 110 has been accepted (step S1401).

The server 501 waits for a backup instruction (No at step S1401). When accepting a backup instruction (Yes at step S1401), the server 501 determines whether or not the second storage device 120 contains a backup list BL for the first storage device 110 (step S1402).

If the second storage device 120 does not contain such a backup list BL (No at step S1402), the server 501 executes a full backup of the first storage device 110 (step S1403). The server 501 generates a backup list BL for the first storage device 110 (step S1404) and then ends the process of the flowchart.

On the other hand, if the second storage device 120 contains a backup list BL for the first storage device (Yes at step 1402), the server 501 executes a differential backup list generation process (step S1405). The differential backup list generation process generates a differential backup list SL describing difference files between the files stored in the first storage device 110 at the point in time when the backup instruction has been accepted and the files on the backup list BL.

The server 501 refers to the generated differential backup list SL and performs a differential backup of the first storage device 110 (step S1406), then ends the process of the flowchart.

A detailed procedure of the differential backup list generation process at step S1405 of FIG. 14 will be described below. Here, the files stored in the first storage device 110 to be backed up are referred to as “files F1 to Fm” and a given file among the files F1 to Fm is referred to as “File Fj” (where j=1, 2, . . . , n).

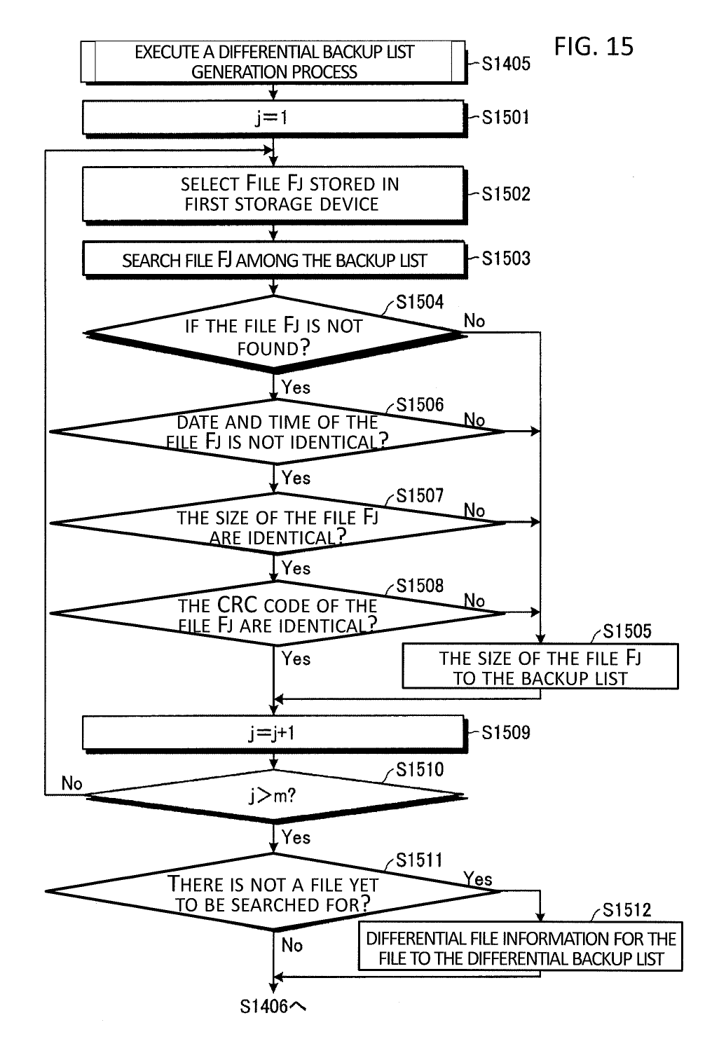

FIG. 15 is a flowchart illustrating an example of the procedure of the differential backup list generation process. In the flowchart in FIG. 15, first the server 501 initializes the index “j” of file Fj to 1 (step S1501) and selects the file Fj (F1) stored in the first storage device 110 (step S1502).

The server 501 then searches the backup list BL of the first storage device 110 for the selected file Fj (step S1503). Specifically, the server 501 searches the backup list BL for the file having the same path name, for example, as the selected file Fj.

If the file Fj is not found (No at step S1504), the server 501 adds difference file information for the file Fj to the backup list SL (step S1505) and proceeds to step S1509.

On the other hand, if the file Fj is found (Yes at step S1504), the server 501 determines whether or not the backup date and time of the selected file Fj and that of the found file Fj are identical to each other (step S1506)

If the backup dates and times of the files Fj are not identical (No at step S1506), the server 501 adds difference file information for the file Fj to the differential backup list SL (step S1505) and then proceeds to step S1509.

On the other hand, if the dates and times of the files Fj are identical (Yes at step S1506), the server 501 determines whether or not the size of the selected file Fj and the size of the found file Fj are identical to each other (step S1507).

If the sizes of the files Fj are not identical (No at step S1507), the server 501 adds difference file information for the file Fj to the differential backup list SL (step S1505) and proceeds to step S1509.

On the other hand, if the sizes of the files Fj are identical (Yes at step S1507), then the server 501 determines whether or not the CRC code of the selected file Fj and that of the found file Fj are identical to each other (step S1508).

If the CRC codes of the files Fj are not identical (No at step s1508), the server 501 adds difference file information for the file Fj to the differential backup list SL (step S1505) and then proceeds to step S1509.

On the other hand, if the CRC codes are identical (Yes at step S1508), the server 501 increments the index “j” of file Fj (step S1509) and determines whether or not “j” is greater than “m” (step S1510).

If “j” is not greater than “m” (No at step S1510), the server 501 returns to step S1502. On the other hand, if “j” is greater than “m” (Yes at step S1510), the server 501 determines whether or not there is a file yet to be searched for on the backup list BL at step S1503 (step S1511).

If there is a file yet to be searched for (Yes at step S1511), the server 501 adds difference file information for the file to the differential backup list SL (step S1512) and then proceeds to step S1406 of FIG. 14. On the other hand, if there is not a file yet to be searched for (No at step S1511), the server 501 proceeds to step S1406 of FIG. 14.

Thus, a backup of the first storage device 110 may be performed. In a second and subsequent backups, differential backups of difference files between the set of files in the first storage device 110 and the set of files on the backup list BL are made, thereby the processing time requested for the backup process may be reduced.

### (Restore Procedure Performed by Server 501)

A restore procedure performed by the server 501 will be described below.

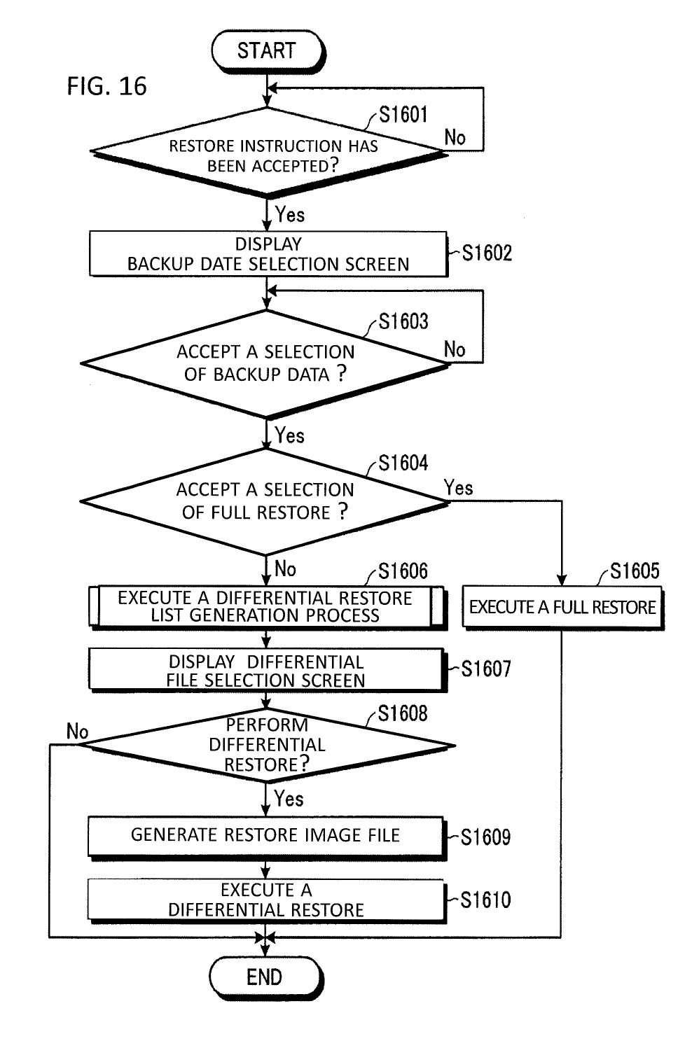

FIG. 16 is a flowchart illustrating an example of the restore procedure performed by the server 501. In the flowchart of FIG. 16, first the server 501 determines whether or not the accepting unit 301 of the server 501 has accepted an instruction to restore the first storage device 110 (step S1601).

The server 501 waits for acceptance of a restore instruction (No at step S1610). Upon acceptance of a restore instruction (Yes at step S1610), the server 501 displays on the display 208 the backup data selection screen (see FIG. 12) for selecting backup data to recover (step S1602).

Then the server 501 determines whether or not the accepting unit 301 has accepted a selection of backup data to recover (step S1603). The server 501 waits for acceptance of a selection of backup data to recover (No step S1603). Upon acceptance (Yes at step S1603), the server 501 determines whether or not the accepting unit 301 has accepted a selection of a full restore (step S1604).

If the accepting unit 301 has accepted a selection of a full restore (Yes at step S1604), the updating unit 303 of the server 501 executes a full restore of the first storage device 110 (step S1605). Then the process of the flowchart ends.

On the other hand, if the accepting unit 301 has accepted a selection of a differential restore (No at step S1604), the generating unit 302 of the server 501 executes a differential restore list generation process (step S1606). The differential restore list generation process generates a differential restore list RL describing difference files between the files stored in the first storage device 110 at the point in time when the restore instruction has been accepted and the files on the backup list BL.

The server 501 then displays the difference file selection screen (see FIG. 13) for selecting difference files to recover on the display 208 (step S1607). The updating unit 303 of the server 501 determines whether or not a differential restore of the first storage device 110 is to be made (step S1608).

Specifically, if the restore start button B1 on the difference file selection screen 1300 has been clicked, for example, the updating unit 303 determines that a differential restore of the first storage device 110 is to be performed. On the other hand, if the cancel button B2 on the difference file selection screen 1300 has been clicked, the updating unit 303 determines that a differential restore of the first storage device 110 is not to be performed.

If a differential restore is performed (Yes at step S1608), the updating unit 303 of the server 501 refers to the differential restore list RL generated at step S1606 and generates a differential restore image file RIF (step S1609). It is noted that difference files with unchecked checkboxes have been deleted from the differential restore list RL in the difference file selection screen 1300.

The updating unit 303 of the server 501 performs a differential restore of the first storage device 110 on the basis of the differential restore list RL and differential restore image file RIF (step S1610). Then the process of the flowchart ends.

A detailed procedure of the differential restore list generation process at step S1606 of FIG. 16 will be described below. Here, the files on the backup list BL are referred to as “files F1 to Fn” and a given file among the files F1 to Fn is referred to as a “file Fi” (where i=1, 2, . . . , n).

The backup list BL is a backup list BL generated during a full backup of the first storage device 110 or a new backup list BL generated by merging a backup list BL generated during a full backup and a differential backup list SL generated during a differential backup.

For example, if “Backup data BD1” has been selected as the backup data to recover at step S1603 of FIG. 16, the backup list BL is a backup list BL generated during a full backup of the first storage device 110.

If “Backup data BD2” has been selected as the backup data to recover, the backup list B1 is a merge of the backup list BL generated during the full backup and differential backup list SL1 generated during a differential backup.

If “Backup data BD3” has been selected as the backup data to recover, the backup list BL is a merge of the backup list BL generated during the full backup and the differential backup lists SL1 and SL2 generated during differential backups.

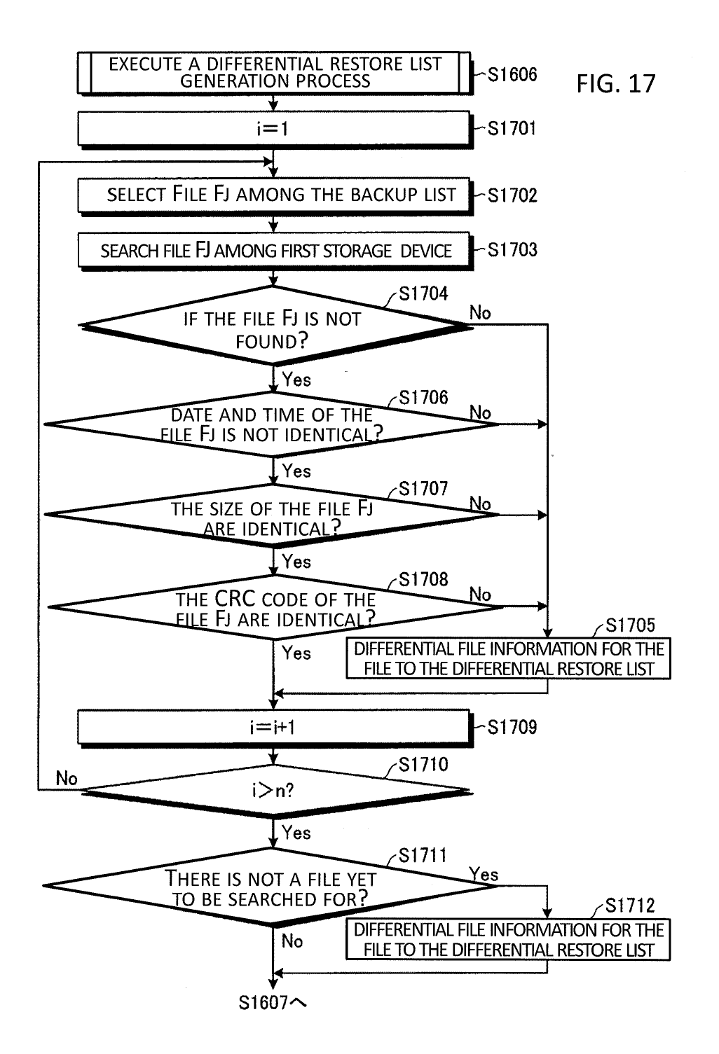

FIG. 17 is a flowchart illustrating a detailed exemplary procedure of the differential restore list generation process. In the flowchart of FIG. 17, first the generating unit 302 of the server 501 initializes the index “i” of file Fi to 1 (step S1701) and selects the file Fi from the backup list BL (step S1702).

The generating unit 302 of the server 501 searches the first storage device 110 for the selected file Fi (step S1703). Specifically, the generating unit 302 of the server 501 searches the first storage device 110 for the file that has the same path name, for example, as the selected file Fi.

If the file Fi is not found (No at step S1704), the generating unit 302 of the server 501 adds difference file information for the file Fi to the differential restore list RL (step S1705), then proceeds to step S1709.

On the other hand, if the file Fi is found (Yes at step S1704), the generating unit 302 of the server 501 determines whether or not the backup date and time of the selected file Fi and the backup date and time of the found file Fi are identical to each other (step S1706).

If the backup dates and times of the files Fi are not identical (No at step S1706), the generating unit 302 of the server 501 adds difference file information for the file Fi to the differential restore list RL (step S1705), then proceeds to step S1709.

On the other hand, if the backup dates and times of the files Fi are identical (Yes at step S1706), the generating unit 302 of the server 501 determines whether or not the size of the selected file Fi and the size of the found file Fi are identical to each other (step S1707).

If the sizes of the files Fi are not identical (No at step S1707), the generating unit 302 of the server 501 adds difference file information for the file Fi to the differential restore list RL (step S1705) and then proceeds to step S1709.

On the other hand if the sizes of the files Fi are identical (Yes at step S1707), the generating unit 302 of the server 501 determines whether or not the CRS code of the selected file Fi and the CRC code of the found file Fi are identical to each other (step S1708).

If the CRC codes of the files Fi are not identical (NO at step S1708), the generating unit 302 of the server 501 adds difference file information for the file Fi to the differential restore list RL (step S1705) and then proceeds to step S1709.

On the other hand, if the CRC codes of the files Fi are identical (Yes at step S1708), the generating unit 302 of the server 501 increments the index “i” of file Fi (step S1709) and determines whether or not “i” is greater than “n” (step S1710).

If “i” is not greater than “n” (No at step S1710), the generating unit 302 of the server 501 returns to step S1702. On the other hand, if “i” is greater than “n”, the generating unit 302 of the server 501 determines whether or not there is a file yet to be found in the first storage device 110 at step S1703 (step S1711).

If there is a file yet to be found in the first storage device 110 (Yes at step S1711), the generating unit 302 of the server 501 adds difference file information of that file to the differential restore list RL (step S1712) and then proceeds to step S1607 of FIG. 16. On the other hand, if there is not a file to be found from the first storage device 110 (No at step S1711), the generating unit 302 directly proceeds to steps S1607 of FIG. 16.

In this way, a differential restore that is limited to only the differential files identified from the differential restore list RL may be performed. Because the amount of data restored is reduced, the processing time requested for the restore may be reduced when compared with a full restore of whole backup data.

As has been described above, the server 501 according to the present embodiment is capable of generating a differential restore list RL describing difference files between the files stored in the first storage device 110 at the point in time when a restore instruction has been accepted and the files on a backup list BL for the first storage device 110. The server 501 is also capable of updating the files in the first storage device 110 with reference to the generated differential restore list RL. This may limit a restore to only the difference files identified from the differential restore list RL. Since the amount of data restored is reduced, the processing time requested for the restore may be reduced when compared with a full restore.

Furthermore, before the start of a restore of first storage device 110, the server 501 may accept a selection of a backup data to be recovered from among backup data taken at different times of backups of the first storage device 110. Thus, the first storage device 110 may be recovered to any point in time at which a backup has been performed.

Moreover, before the start of a restore of the first storage device 110, the server 501 may accept a selection of difference files to be recovered from among difference files identified from the differential restore list RL. Thus, restore may be limited to only desired difference files.

When a restore of data on a system in operation needs to be performed offline, the server 501 may perform the restore with minimum system downtime. The server 501 also may perform a restore without shutting down the system, depending on the contents in difference files.

The data recovery method described with respect to the present embodiments may be implemented by causing a computer such as a personal computer or a workstation to execute a program provided beforehand. The data recovery program is recorded on a computer-readable recording medium such as a hard disk, a flexible disk, a CD-ROM, an MO, or a DVD and is executed by the computer reading the data recovery program from the recording medium. The data recovery program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A data recovery apparatus comprising:
accepting unit configure to accept an instruction to recover data in a first storage device;
generating unit configure to generate difference information representing differences between backup data stored in a second storage device backed up from the first storage device and first data stored in the first storage device at the point in time when the accepting unit receives the data recovery instruction; and
updating unit configure to update data stored in the first storage device on the basis of the difference information generated by the generating unit and the backup data.

2. The data recovery apparatus according to claim 1, wherein:
the second storage device stores backup data backed up from the first storage device at different times, the backup data being organized by their respective backup time points;
the accepting unit accepts an instruction to select any given backup data from among the backup data stored in the second storage device organized by their respective backup time points; and
the generating unit generates difference information representing differences between the given backup data selected and the first data stored in the first storage device at the point in time when the accepting unit receives the data recovery instruction.

3. The data restore apparatus according to claim 1, further comprising comparing unit configure to compare the first data stored in the first storage device at the point in time when the data recovery instruction has been accepted with second data stored in the second storage device, wherein:
the generating unit generates the difference information representing differences between the first data and the second data on the basis of the result of comparison by the comparing unit.

4. The data recovery apparatus according to claim 3, further comprising:
display unit configure to display difference data representing differences between the first data and the second data on a display screen, the difference data being identified from the difference information, wherein:
the accepting unit accepts an instruction to select any given difference data from among the difference data displayed on the display screen; and
the updating unit updates the first data stored in the first storage device on the basis of the given difference data selected.

5. A data recovery method is performed by computer, the data recovery method comprising:
accepting an instruction to recover data in a first storage device;
generating difference information describing differences between backup data backed up from the first storage device to a second storage device and the set of first data stored in the first storage device at the point in time when the data recovery instruction has been received in the accepting; and
updating data stored in the first storage device on the basis of the difference information generated in the generating and the backup data.

6. A computer-readable, non-transitory medium storing a program that causes a computer to execute a data recovery procedure, the data recovery procedure comprising:
accepting an instruction to recover data in a first storage device;
generating difference information indicating differences between backup data backed up from the first storage device to a second storage device and first data stored in the first storage device at the point in time when the data recovery instruction has been received; and
updating data stored in the first storage device on the basis of the generated difference information and the backup data.
